(19) United States
(12) Patent Application Publication
(10) Pub. No.: US 2016/0237963 A1
(43) Pub. Date: Aug. 18, 2016

(54) CONNECTOR AND MANUFACTURING PROCESS FOR THE SAME

(71) Applicant: Sumitomo Riko Company Limited, Komaki-shi (JP)

(72) Inventor: Yorihiro TAKIMOTO, Komaki-shi (JP)

(73) Assignee: Sumitomo Riko Company Limited, Komaki-shi (JP)

(21) Appl. No.: 15/138,135

(22) Filed: Apr. 25, 2016

Related U.S. Application Data
(63) Continuation of application No. PCT/JP2015/077905, filed on Oct. 1, 2015.

(30) Foreign Application Priority Data
Oct. 3, 2014 (JP) 2014-204489

(51) Int. Cl. F02M 37/00; F16L 37/06; F16L 55/04

(52) U.S. Cl. CPC F02M 37/0017; F16L 55/04; F16L 37/06; B29C 45/2614

(57) ABSTRACT

A connector includes: a first-pipe insertion portion made of resin, formed as a tubular shape, and including a first opening into which a first pipe is inserted; and a second-pipe installation portion made of resin, and formed as a tubular shape integrally with the first-pipe insertion portion by integral molding, second-pipe installation portion on which a second pipe is installed on the outer peripheral side from a side of the second opening. The second-pipe installation portion includes: a tubular section forming a second flow passage on a second-pipe installation portion second opening side; and a wall section not only demarcating a first flow passage in the first-pipe insertion portion from the second flow passage in the tubular section but also formed so as to elongate in the same direction as the second flow passage does, and forming an orifice communicating the first flow passage with the second flow passage.

### CROSS REFERENCE TO RELATED APPLICATIONS

The present application is a Continuation Application of International Application No. PCT/JP2015/077905, filed on Oct. 1, 2015, which is incorporated herein by reference The present invention is based on Japanese Patent Application No. 2014-204489, filed on Oct. 3, 2014, the entire contents of which are incorporated herein by reference.

### BACKGROUND OF THE INVENTION

1. Field of the Invention

The present invention relates to a connector connecting a first pipe with a second pipe, and to a manufacturing process for the same.

2. Description of the Related Art

For example, piping to be applied to an automotive fuel supply system carries out transferring a fuel by pressurizing the fuel within the piping by a pump so as to make a set-up constant pressure therein. When an injection apparatus, such as an injector, is opened and closed in order to control a supply of the fuel, the pressure within the piping fluctuates so that the fuel pulsates. When the fuel pulsates, excess and deficiency occur in a pressure of the fuel at the injector apparatus, and accordingly such a fear might possibly arise as errors occur in an amount of the fuel to be injected by the injector apparatus with respect to the desired amount.

Hence, in a connector set forth in Japanese Unexamined Patent Publication (KOKAI) Gazette No. 2011-163154 (Patent Literature 1), a cylinder is disposed in a housing, and then a piston moves within the cylinder, in order to reduce pulsating motions. Incidentally, various piping constructions are set forth in Japanese Unexamined Patent Publication (KOKAI) Gazette No. 2005-163836 (Patent Literature 2), Japanese Unexamined Utility Model Publication (KOKAI) Gazette No. 2-85606 (Patent Literature 3), Japanese Unexamined Patent Publication (KOKAI) Gazette No. 2008-57388 (Patent Literature 4) and Japanese Unexamined Patent Publication (KOKAI) Gazette No. 9-257185 (Patent Literature 5), although they are not for the purpose of reducing pulsating motions. Patent Literature 2 sets forth a connector having a built-in valve. Patent Literature 3 sets forth a piping construction for air suspension, the piping construction having an orifice. Patent Literature 4 sets forth a distribution member for vaporized fuel, the distribution member having an orifice. Patent Literature 5 sets forth a tube having an orifice.

Since the connector set forth in Patent Literature 1 is disposed so that part of the cylinder protrudes from out of the housing, the entire connector increases in size.

Objects of the present invention are to provide a connector that can reduce pulsating motions without increasing in size, and to provide a manufacturing process for the same.

### SUMMARY OF THE INVENTION

A quick connector directed to the present invention is a connector connecting a first pipe with a second pipe, and comprises:

a first-pipe insertion portion made of resin, formed as a tubular shape, and including a first opening into which the first pipe is inserted; and
a second-pipe installation portion made of resin, and formed as a tubular shape integrally with the first-pipe insertion portion by integral molding, the second-pipe installation portion on which the second pipe is installed on an outer peripheral side thereof from a side of a second opening thereof.

The second-pipe installation portion includes:

a tubular section forming a second flow passage on a side of the second opening of the second-pipe installation portion; and
a wall section not only demarcating a first f low passage in the first-pipe insertion portion from the second flow passage in the tubular section but also formed so as to elongate in the same direction as the second flow passage does, and forming an orifice communicating the first flow passage with the second flow passage.

The first pipe is inserted into the first-pipe insertion portion of the connector. The second pipe is installed on an outer peripheral side of the second-pipe installation portion of the connector. Thus, the connector connects the first pipe with the second pipe. The first-pipe insertion portion, and the second-pipe installation portion are molded integrally by resin. Consequently, the connector exhibits high strength.

Moreover, the connector further comprises the orifice. The orifice is formed in the wall section that makes a demarcation between the first-pipe insertion portion and the tubular section of the second-pipe installation portion. Therefore, pulsating motions are reduced in fluid that passes through the first flow passage in the first-pipe insertion portion, the orifice in the wall section of the second-pipe installation portion and the second flow passage in the tubular section of the second-pipe installation portion. The connector can reduce the pulsating motions without disposing any such other structural bodies as a cylinder and piston, in addition to the flow passages. That is, the connector can reduce the pulsating motions without increasing in size.

In addition, the orifice is formed so as to elongate in the same direction as the second flow passage does in the tubular section of the second-pipe installation portion. A core for forming the second flow passage accordingly makes it feasible to form the orifice simultaneously with the second flow passage. Therefore, it becomes feasible to integrally mold the first-pipe insertion portion and second-pipe installation portion securely, while forming the orifice.

Moreover, a manufacturing process for the connector directed to the present invention uses;

an outer mold forming an outer face of the connector;
a first core forming an inner peripheral face of the first-pipe insertion portion; and
a second core forming an inner peripheral face of the tubular section of the second-pipe installation portion, and the orifice in the wall section; and
the manufacturing process comprises:
an arrangement step of arranging the first core and the second core inside the outer mold; and
a resin injection step of injecting molten resin into a cavity formed between the first core, the second core and the outer mold.

In accordance with the present manufacturing process, it becomes feasible to integrally mold the first-pipe insertion portion and second-pipe installation portion securely, while forming the orifice.

### BRIEF DESCRIPTION OF THE DRAWINGS

FIG. 1 is a perspective-view diagram of a connector 1 according to First Embodiment before it is connected with a first pipe 3 and a second pipe 4;

FIG. 2 is a cross-sectional diagram of the connector 1 according to First Embodiment taken in the flow-passage direction in a state where it is connected with the first pipe 3 and second pipe 4;

FIG. 3 is a cross-sectional diagram of the connector 1 alone taken along the “3”-“3” line in FIG. 2;

FIG. 4 is a cross-sectional diagram of the connector 1 alone taken along the “4”-“4” line in FIG. 2;

FIG. 5 is a cross-sectional diagram illustrating a forming mold for molding the connector 1 according to First Embodiment; and

FIG. 6 is a cross-sectional diagram of a connector 100 according to Second Embodiment taken in the flow-passage direction.

### DESCRIPTION OF THE EMBODIMENTS

### First Embodiment

(1) Outline of Connector 1

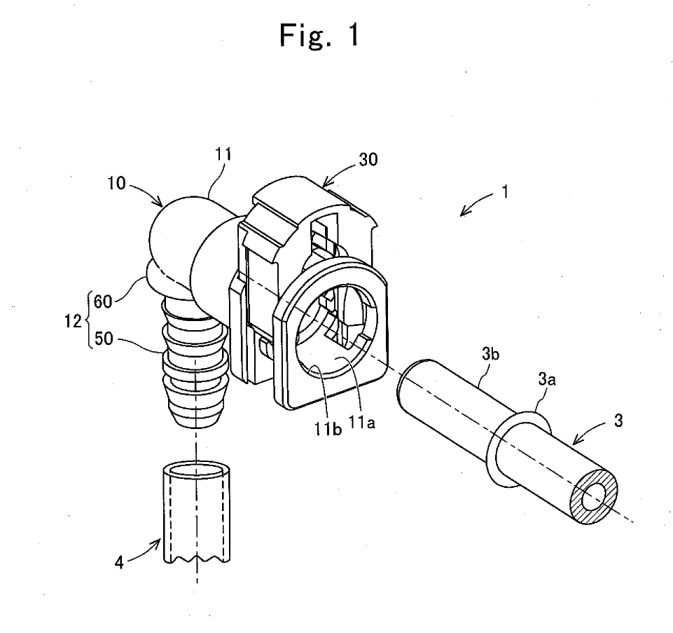

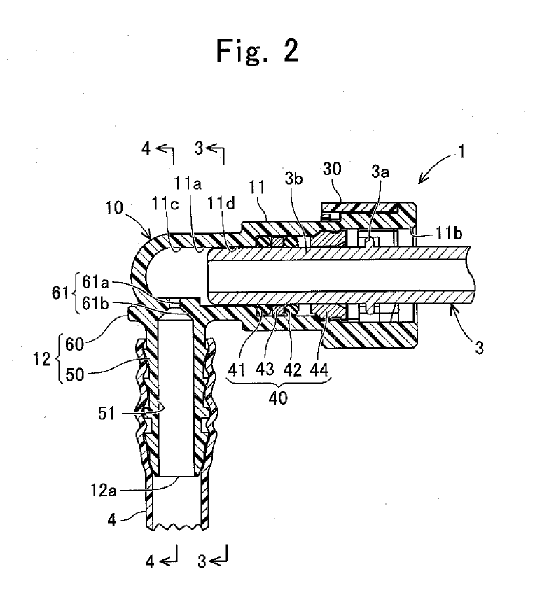

Regarding an outline of a connector 1 according to the present embodiment, explanations will be made with reference to FIG. 1 and FIG. 2. The connector 1 is used for constituting automotive fuel piping, for instance. Note that, in addition to the fuel piping, the connector 1 is also applied to the other piping variously. In the present embodiment, the connector 1 forms a flow passage for distributing a fuel. As illustrated in FIG. 1 and FIG. 2, a first pipe 3 made of a metal, for instance, is inserted into the connector 1, and a second pipe 4 made of a resin, for instance, is installed thereon. Thus, the connector 1 connects the first pipe 3 with the second pipe 4.

As illustrated in FIG. 1, the first pipe 3 is formed in a metallic tubular shape, for instance, and is provided with an annular boss 3a (being also referred to as a “flanged portion,” or a “bead”) formed to protrude outwardly in the diametric direction at a position that is separated off at a distance from the leading end in the axial direction. In the following explanations, a minor-diameter part of the first pipe 3, which is present on a more leading-end side than the annular boss 3a, is designated as a leading-end portion 3b thereof.

The connector 1 comprises a connector body 10, a retainer 30, and a sealing unit 40. The connector body 10 is formed integrally by a resin. The connector body 1 is made of glass-fiber reinforced polyamide, for instance. The connector body 10 is molded so as to have penetrated flow passages (11a, 61, 51) therein. The connector body 10 shown in. FIG. 1 exhibits a configuration that is formed to penetrate in a letter-“L” shape.

As illustrated in FIG. 1 and FIG. 2, the connector body 10 comprises a first-pipe insertion portion 11 into which the first pipe 3 is inserted, and a second-pipe installation portion 12 on whose outer peripheral surface the second pipe 4 is installed. The first-pipe insertion portion 11, and the second-pipe installation portion 12 are molded integrally by a resin. Consequently, the connector body 10 exhibits high strength.

The first-pipe insertion portion 11 is formed in a tubular shape to form a first flow passage 11a therein. The first-pipe insertion portion 11 has a first opening 11b through which the first pipe 3 is inserted. Into the first-pipe insertion portion 11, parts of the first pipe 3, such as the leading-end portion 3b and annular boss 3a, are inserted. On an axial central section of the inner peripheral side in the first-pipe insertion portion 11, the sealing unit 40 is arranged.

The second-pipe installation portion 12 is formed in a tubular shape to make the second pipe 4 install on the outer peripheral side starting at a side of the second opening 12a. A flow passage in the second-pipe installation portion 12 is communicated with the first flow passage 11a in the first-pipe insert ion port ion 11. The outer peripheral face of the second-pipe installation portion 12 is formed in an irregular or zigzagged shape in a direction along the flow passage in order not to make the second pipe 4, which is put in a state of being fitted around, fall off therefrom.

The retainer 30 is made of glass-fiber reinforced polyamide, for instance. The retainer 30 is retained in the first-pipe insertion portion 11 of the connector body 10. The retainer 30 is capable of moving in the diametric direction of the first-pipe insertion portion 11 through a push-in operation and pull-out operation by an operator or worker. When the first pipe 3 has been inserted into the first-pipe insertion portion 11 to a normal position therein, the retainer 30 becomes movable from an initial position shown in FIG. 1 to a confirmation position shown in FIG. 2. Therefore, when the operator or worker can operate the retainer 30 by the push-in operation, he or she can confirm that the first pipe 3 has been inserted into the first-pipe insertion portion 11 to the normal position.

Moreover, in a state where the retainer 30 is operated to be pushed in to the confirmation position, the retainer 30 locks the annular boss 3a of the first pipe 3 in a pipe pull-out direction, thereby stopping the first pipe 3 from coming off. That is, an operator or worker can confirm the following by operating the retainer 30 to push in: the first pipe 3 has been inserted into the first-pipe insertion portion 11 to the normal position; and the first pipe 3 is stopped from coming off by the retainer 30.

The sealing unit 40 is constituted of the following, for instance: annular sealing members (41, 42) made of fluororubber; a collar 43 made of a resin and held between the annular sealing members (41, 42) in the axial direction; and a bushing 44 made of a resin for positioning the annular sealing member (41, 42) and collar 43 in the first-pipe insertion portion 11. As illustrated in FIG. 2, the leading-end potion 3b of the first pipe 3 is inserted into the inner peripheral side of the sealing unit 40; and the annular boss 3a of the first pipe 3 is positioned on a side more adjacent to the first opening 11b than the sealing unit 40 is positioned.
(2) Detailed Construction of Connector Body 10

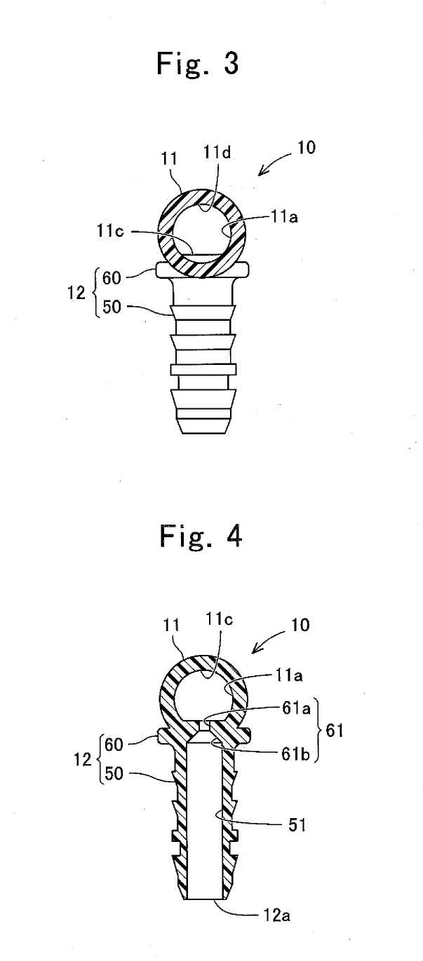

Regarding detailed construction of the connector body 10, explanations will be made hereinafter with reference to FIG. 2 through FIG. 4. The second-pipe installation portion 12 comprises the tubular section 50, and the wall section 60. The tubular section 50 forms the second flow passage 51 on a side of the second opening 12a. An inner peripheral face of the tubular section 50 is formed as a cylindrical face. An outer peripheral face of the tubular section 50 is formed in an irregular or zigzagged shape in a direction along the second flow passage 51. Therefore, an inside diameter of the tubular section 50 is formed to be smaller than an inside diameter of the second pipe 4.

The wall section 60 demarcates the first flow passage 11a in the first-pipe insertion portion 11 from the second flow passage 51 in the tubular section 50. The wall section 60 forms the orifice 61 communicating the first flow passage 11a with the second flow passage 51. A cross-sectional area of the orifice 61 is smaller than a flow-passage cross-sectional area of the first flow passage 11a and a flow-passage cross-sectional area of the second flow passage 51.

The orifice 61 is formed so as to elongate in the same direction as does the second flow passage 51 in the tubular section 50. In the present embodiment, the orifice 61 is formed coaxially with the inner peripheral face of the tubular section 50. The orifice 61 comprises a cylindrical inner-peripheral section 61a, and a tapered section 61b.

The cylindrical inner-peripheral section 61a is positioned on a side of the first flow passage 11a, and opens in the first flow passage 11a. The cylindrical inner-peripheral section 61a has an identical inside diameter in the axial direction. The tapered inner-peripheral section 61b is positioned on a side of the second flow passage 51, and opens in the second flow passage 51. The tapered inner-peripheral section 61b communicates the second flow passage 51 with the cylindrical inner-peripheral section 61a. The tapered inner-peripheral section 61b has an inner peripheral face shaped as a circular truncated cone. The tapered inner-peripheral section 61b is reduced diametrically from the second flow passage 51 toward the cylindrical inner-peripheral section 61a.

In the present embodiment, the first-pipe insertion portion 11 and second-pipe installation portion 12 are formed in a letter-“L” shape. That is, the central axis of the first flow passage 11a in the first-pipe insertion portion 11, and the central axis of the second flow passage 12 in the tubular section 50 of the second-pipe insertion portion 12 exhibit an angle of 90 degrees one another at. And, the central axis of the orifice 61 is coaxial with the central axis of the second flow passage 51.

Therefore, one of the opposite faces of the wall section 60 (i.e., the upper face in FIG. 2) constitutes a peripheral wall face of the first flow passage 11a, and another one of the opposite faces of the wall section 60 (i.e., the lower face in FIG. 2) constitutes an end wall face of the second flow passage 51. That is, the cylindrical inner-peripheral section 61a of the orifice 61 opens in the peripheral wall face of the first flow passage 11a.

The one of the opposite faces of the wall section 60 (i.e., the upper face in FIG. 2 through FIG. 4) is formed in a shape of flat face. Therefore, a flow-passage length of the cylindrical inner-peripheral section 61a becomes identical throughout the entire circumference. That is, on a side of the first flow passage 11a, the cylindrical inner-peripheral section 61a has an opening configuration that becomes a circular shape identical with a cross-sectional inner-peripheral-face configuration that the cylindrical inner-peripheral section 61a has in the diametrical direction.

Note herein that, on an inner side of the flow passage 11a in the first-pipe insertion portion 11, an innermost part 11c involving the one of the opposite faces of the wall section 60 is formed in a noncircular shape. That is, since the one of the opposite faces of the wall section 60 has a planar shape, some of the peripheral face of the innermost part 11c is formed in a planar shape. The remaining peripheral face of the innermost part 11c is formed in an arc shape.

In the first flow passage 11a, the leading-end portion 3b of the first pipe 3 is inserted between the innermost part 11c and the installation part of the sealing unit 40. The part is hereinafter referred to as a pipe leading-end arrangement part 11d. The pipe leading-end arrangement part 11d has a circular cross-sectional configuration corresponding to the leading-end portion 3b of the first pipe 3.

The arc-shaped peripheral face of the innermost part 11c is positioned on an extension of the circular inner-peripheral face of the pipe leading-end arrangement part 11d. Meanwhile, the planar-shaped peripheral face of the innermost part 11c, namely, the one of the opposite faces of the wall section 60 is positioned so as to protrude more inward in the diametric direction than does the position of the inner peripheral face of the pipe leading-end arrangement part 11d. Therefore, the innermost part 11d is formed as a configuration that makes it impossible to insert the leading-end portion 3b of the first pipe 3. And, the innermost part 11c, namely, the one of the opposite faces of the wall section 60 is positioned on a more inner side in the first flow passage 11a than is the leading-end face of the leading-end portion 3b of the first pipe 3.
(3) Liquid Flows within Connector 1

The connector body 10 comprises the orifice 61 communicating the first flow passage 11a with the second flow passage 51. The orifice 61 is formed in the wall section 60 that makes a demarcation between the first-pipe insertion portion 11 and the tubular section 50 of the second-pipe installation section 12. Therefore, pulsating movements are reduced in a fluid passing through the first flow passage 11a in the first-pipe insertion portion 11, the orifice 61 in the wall section 60 of the second-pipe installation portion 12, and the second flow passage 51 in the tubular section 50 of the second-pipe installation portion 12. According to the connector body 10, it is possible to reduce the pulsating movements without disposing any such structural bodies as a cylinder and piston, in addition to the flow passages. That is, it is possible to reduce the pulsating movements without increasing the connector body 10 in size.
(4) Manufacturing Process for Connector Body 10

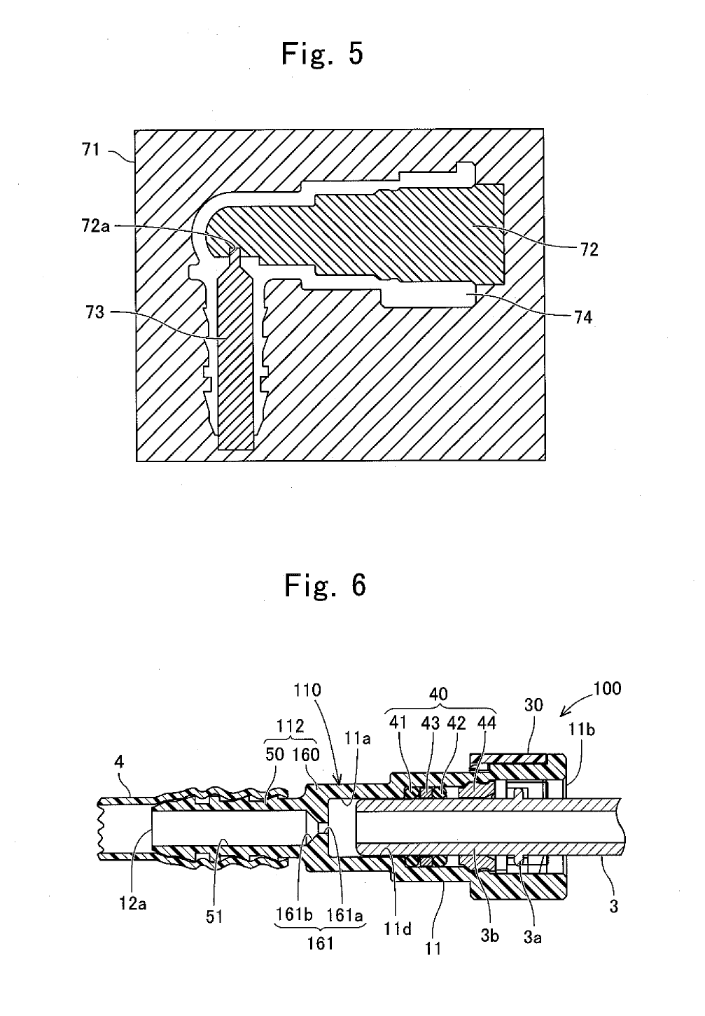

Regarding a manufacturing process for the connector body 10, explanations will be made hereinafter with reference to FIG. 5. The connector body 10 is manufactured by injection molding. Hence, as illustrated in FIG. 5, the following are used in manufacturing the connector body 10: two or more outer molds 71 forming the outer faces of the connector body 10; a first core 72 forming the inner peripheral faces of the first-pipe insertion portion 11; and a second core 73 forming the inner peripheral faces of the tubular section 50 of the second-pipe installation portion 12 as well as the orifice 61 in the wall section 60.

And, an operator or worker arranges the first core 72 and second core 73 inside the outer molds 71 (i.e., an arrangement step); subsequently, the operator or worker injects a molten resin into a cavity 74 formed between the first core 72, the second core 73 and the outer molds 71 (i.e., a resin injection step). Subsequently, the operator or worker removes the outer molds 71, the first core 72, and the second core 73 (i.e., a mold separation step). Thus, the connector body 10 is manufactured.

Note herein that, as illustrated in FIG. 5, the first core 72 is formed in an axial shape. The leading end of the first core 72 is formed in configurations corresponding to the innermost part 11c and pipe leading-end arrangement part 11d of the first flow passage 11a. That is, the cross-sectional configuration of the first core 72 becomes smaller as it goes to the leading end. The second core 73 is formed in an axial shape. The second core 73 is formed, as it goes to the leading end, in configurations corresponding to the following in the order of the second flow passage 51 in the tubular section 50 and the tapered inner-peripheral section 61b and cylindrical inner-peripheral section 61a of the orifice 61. That is, the cross-sectional configuration of the second core 73 becomes smaller as it goes to the leading end.

Thus, the cross-sectional configurations of the first core 72 and second core 73 are both formed to be smaller as they go to the leading end. And, the orifice 61 is formed so as to elongate in the same direction as the second flow passage 51 does. That is, the second core 73 for forming the second flow passage 51 makes it feasible to form the orifice 61 simultaneously with the second flow passage 51. Therefore, constituting the connector body 10 as set forth above leads to making it feasible to securely mold the first-pipe insertion portion 11 and second-pipe installation portion 12 integrally while forming the orifice 61.

If the orifice 61 should have been formed in the vicinity of the second opening 12a of the second-pipe installation portion 12, it is not possible to integrally mold the connector body 10. It is reasoned that a core similar to the second core 73 makes an undercut configuration so that it cannot be pulled or drawn out from a product.

Moreover, the second core 73 further comprises a tapered portion, which corresponds to the tapered inner-peripheral section 61b of the orifice 61, between the major-diameter portion, which corresponds to the second flow passage 51 in the tubular section 50, and the minor-diameter portion, which corresponds to the cylindrical inner-peripheral section 61a of the orifice 61. Therefore, the second core 73 does not change to make the diameter smaller sharply as it goes to the leading end, but changes to make it smaller gradually. Consequently, even when the leading-end portion of the second core 73 comprises the minor-diameter portion, it exhibits high strength.

Moreover, a radial dent 72a is formed, as shown in FIG. 5, at a position in some of the leading-end portion of the first core 72 corresponding to the innermost part 11c. A minor-diameter portion in the second core 73 corresponding to the cylindrical inner-peripheral section 61a is formed to be longer than the actual axial length of the cylindrical inner-peripheral section 61a. The minor-diameter portion is inserted into the dent 72a of the first core 72. Therefore, the orifice 61 opens in the first flow passage 11a securely.

### Second Embodiment

Regarding a connector 100 according to the present embodiment, explanations will be hereinafter made with reference to FIG. 6. In contrast to the connector 1 according to First Embodiment, the connector 100 according to the present embodiment is distinct in that a connector 110 is not a letter-“L” type but has a linear shape. Note that, of the constituents of the connector 1 according to First Embodiment, identical constituents therewith in the connector 100 according to the present embodiment are labeled with the same reference numerals to omit the explanations hereinafter.

The connector 100 comprises the connector 110, a retainer 30, and a sealing unit 40. The connector body 110 is molded integrally by a resin. As illustrated in FIG. 6, the connector body 110 is molded so as to include flow passages (11a, 161, 51) penetrating therethrough in a linear manner.

The connector body 110 comprises a first-pipe insertion portion 11, and a second-pipe installation portion 112. The second-pipe installation portion 112 includes a tubular section 50, and a wall section 160. In the same manner as the tubular sect ion 50 according to First Embodiment, the tubular section 50 forms a second flow passage 51 therein on a side of the second opening 12a.

The wall section 160 demarcates the first flow passage 11a in the first-pipe insertion portion 11 from the second flow passage 51 in the tubular section 50. The wall section 160 forms an orifice 161 communicating the first flow passage 11a with the second flow passage 51. A cross-sectional area of the orifice 161 is smaller than a cross-sectional area of the first flow passage 11a and a cross-sectional area of the second flow passage 51.

The orifice 161 is formed so as to elongate in the same direction as do the first flow passage 11a in the first-pipe insertion portion 11 and the second flow passage 51 in the tubular section 50. In the present embodiment, the orifice 161 is formed coaxially with the inner peripheral face of tubular section 50. The orifice 161 comprises a cylindrical inner-peripheral section 161a, and a tapered inner-peripheral section 161b.

In the present embodiment, the first-pipe insertion portion 11, and the second-pipe installation portion 112 are formed on a straight line. That is, a central axis of the first flow passage 11a in the first-pipe insertion portion 11, and a central axis of the second flow passage 51 in the tubular section 50 of the second-pipe installation portion 112 are disposed coaxially. And, a central axis of the orifice 161 is coaxial with the central axes of the first flow passage 11a and second flow passage 51.

Therefore, one of the opposite faces of the wall section 160 (i.e., the right face in FIG. 6) constitutes an end wall face of the first flow passage 11a, and another one of the opposite faces of the wall section 160 (i.e., the left face in FIG. 6) constitutes an end face of the second flow passage 51. The cylindrical inner-peripheral section 161a of the orifice 161 opens in the end wall face of the first flow passage 11a. Moreover, the one of the opposite faces of the wall section 160 (i.e., the right face in FIG. 6) is formed in a shape of flat face. Therefore, a flow-passage length of the cylindrical inner-peripheral section 161a becomes identical throughout the entire circumference. That is, on a side of the first flow passage 11a, the cylindrical inner-peripheral section 161a has an opening configuration that becomes a circular shape identical with a cross-sectional inner-peripheral-face configuration that the cylindrical inner-peripheral section 161a has in the diametrical direction.

In the same manner as the connector 1 according to First Embodiment, the connector 100 according to the present embodiment can reduce pulsating movements.

Moreover, the wall section 160 including the orifice 161 is formed between the first flow passage 11a and the second flow passage 51. Accordingly, in manufacturing the connector body 110, the following come to be used: a first core to be pulled or drawn out through the first opening 11b; and a second core to be pulled or drawn out through the second opening 12a. It is possible to make each of the axial lengths of the first core and second core shorter, and so it is possible to secure strengths of the first core and second core sufficiently. Consequently, in an instance where the connector body 110 is molded integrally, the connector body 110 becomes satisfactory in the moldability.

What is claimed is:

1. A connector connecting a first pipe with a second pipe, the connector comprising:
a first-pipe insertion portion made of resin, formed as a tubular shape, and including a first opening into which the first pipe is inserted; and
a second-pipe installation portion made of resin, and formed as a tubular shape integrally with the first-pipe insertion portion by integral molding, the second-pipe installation portion on which the second pipe is installed on an outer peripheral side thereof from a side of a second opening thereof;
the second-pipe installation portion including:
a tubular section forming a second flow passage on a side of the second opening of the second-pipe installation portion; and
a wall section not only demarcating a first flow passage in the first-pipe insertion portion from the second flow passage in the tubular section but also formed so as to elongate in the same direction as the second flow passage does, and forming an orifice communicating the first flow passage with the second flow passage.

2. The connector according to claim 1, wherein:
the orifice includes:
a cylindrical inner-peripheral section opening in the first flow passage in the first-pipe insertion portion; and
a tapered inner-peripheral section communicating the second flow passage with the cylindrical inner-peripheral section, and reducing diametrically from the second flow passage toward the cylindrical inner-peripheral section.

3. The connector according to claim 2, wherein:
a central axis of the first flow passage, and a central axis of the second flow passage exhibit an angle one another;
one of opposite faces of the wall section constitutes a peripheral wall face of the first flow passage;
another one of the opposite faces of the wall section constitutes an end wall face of the second flow passage; and
the cylindrical inner-peripheral section opens in the peripheral wall face of the first flow passage.

4. The connector according to claim 3, wherein:
the one of the opposite faces of the wall section is formed as a planar shape; and
a flow-passage length of the cylindrical inner-peripheral section is throughout a whole circumference thereof.

5. The connector as set forth in claim 4, wherein the one of the opposite faces of the wall section is positioned on an inner side than a leading-end face of the first pipe.

6. The connector according to claim 2, wherein:
a central axis of the first flow passage, and a central axis of the second flow passage are disposed coaxially;
one of opposite faces of the wall section constitutes an end wall face of the first flow passage;
another one of the opposite faces of the wall section constitutes an end face of the second flow passage; and
the cylindrical inner-peripheral section opens in the end wall face of the first flow passage.

7. A manufacturing process for the connector according to claim 1, the production process using:
an outer mold forming an outer face of the connector;
a first core forming an inner peripheral face of the first-pipe insertion portion; and
a second core forming an inner peripheral face of the tubular section of the second-pipe installation portion, and the orifice in the wall section;
the production process comprising:
an arrangement step of arranging the first core and the second core inside the outer mold; and
a resin injection step of injecting molten resin into a cavity formed between the first core, the second core and the outer mold.
